(19) United States
(12) Patent Application Publication
(10) Pub. No.: US 2007/0200818 A1
(43) Pub. Date: Aug. 30, 2007

(54) IMAGE DISPLAY DEVICE

(76) Inventors: Mitsuhide Miyamoto, Kokubunji (JP); Hajime Akimoto, Kokubunji (JP)

Correspondence Address: Mattingly Stanger and Malur PC, Ste 370, 1800 Diagonal Rd, Alexandria, VA, 22314, US

(21) Appl. No.: 11/673,836

(22) Filed: Feb. 12, 2007

(30) Foreign Application Priority Data
Feb. 23, 2006 (JP) 2006-046622

(51) Int. Cl. G09G 3/36

(52) U.S. Cl. 345/104

(57) ABSTRACT

An image display device for displaying a screen containing both moving image data, and image data stored in the internal memory with lower power consumption. The image display device contains a switch for controlling transfer to a display area for image data stored in the internal memory installed outside the display area, and a switch for controlling transfer to a display area for image data (such as moving image data) other than the image data stored in the internal memory. The image display device controls switching according to the display position of both image data types.

### CLAIM OF PRIORITY

The present invention claims priority from Japanese application JP 2006-046622 filed on Feb. 23, 2006, the content of which is hereby incorporated by reference into this application.

### FIELD OF THE INVENTION

The present invention relates to an image display and relates in particular to an image display device with an internal memory and low power consumption.

### BACKGROUND OF THE INVENTION

Display devices in mobile equipment require both high image quality and low power consumption. However, in recent years along with the progress in higher definition, liquid crystal display devices for cellular telephones in particular also display moving images so that attaining both high picture quality and lower power consumption has become difficult. Pixel configurations and drive methods that lower power consumption in the image display device are being proposed to resolve such problems. Image display devices containing internal memories are one example. Image display devices containing internal memories store static (picture) image data in the internal memory and therefore possess low power consumption since input of image data is not required while continuing the static image display. One method of the known art for image display device with internal memories, displays a synthesized image made from a static image stored in the memory and moving image data sent from outside the image display device. The technology in JP-A No. 194205/1996 and in JP-A No. 331490/1997 are examples of methods for storing a memory function within the pixels, and only the moving image data is sent to the pixel section that performs moving image display. The technology in JP-A No. 76721/1996 is an example of a method where the liquid crystal driver contains an internal memory, and data is sent to the liquid crystal (display) while switching each scanning line in the liquid crystal driver, between data within the memory and moving image data sent from the outside.

When these image display devices show the static image and the moving image on the same screen, the static image data is already inside the memory, and only the moving image data is input externally, so there is no need to input all the image data from outside the device and low power consumption is achieved.

### SUMMARY OF THE INVENTION

The image display devices described above where the memory function was contained within the pixels, required a larger pixel surface area so that reducing the device circuit size was impossible. The image display device that selected moving image data and memory (data) within the liquid crystal driver for each scanning line and transferring that data to the panel section also always required a digital/analog converter device for sending data so that reducing power consumption in the liquid crystal driver was impossible. Moreover, the drive system for switching each scanning line to a static image or a moving image was incapable of switching the static image or a moving image scanning directions.

The present invention therefore has the object of providing an image display device capable of displaying a composite image of image data stored in the internal memory, and other image data (such as moving image data) without increasing the pixel surface area.

An example of a typical means of the invention disclosed in this application is described as follows. Namely, the image display device of the present invention is an image display device with plural data lines for transferring image data and, plural scanning lines arrayed to intersect the plural data lines and, plural pixels corresponding to each of the points where the plural data lines and plural scanning lines intersect, and is characterized in containing; a first memory for storing a first data by utilizing a thin film transistor in an area outside the display area on the substrate where the display area for displaying the image is mounted, and a digital/analog converter unit for converting digital image signals to analog image signals, and the image data to be sent on the plural data lines is selected for each data line from either a first image data stored in the first memory, or a second image data different from the first image data; and the image for the selected first image data and the image for the selected second image data are sent in the period that one line among the plural scanning lines is selected, and are shown on the display area.

The image display device of this invention contains an internal memory that is outside the display area, and operates an image data input selector switch to select each scanning line so that low power consumption is achieved since only moving image data is newly loaded when simultaneously displaying a static image and a moving image.

### BRIEF DESCRIPTION OF THE DRAWINGS

FIG. 1 is a block diagram showing the structure of the first embodiment of the image display device of this invention;

FIG. 2 is a drawing showing an example of the internal memory of the image display device of this invention;

FIG. 3 is a drawing showing another example of the internal memory of the image display device of this invention;

FIG. 4 is a drawing showing the structure of the panel section of the first embodiment;

FIG. 5 is a drawing showing an example of the composite image made up of the static image and the moving image;

FIG. 6 is a drawing showing the transfer of image data to the display area;

FIG. 7 is a drawing showing the transfer of image data to the display area;

FIG. 8 is a drawing showing the structure of the panel section of the second embodiment of the image display device of this invention;

FIG. 9 is a block diagram showing the structure of the panel of the second embodiment;

FIG. 10 is a figure showing a timing chart for the second embodiment;

FIG. 11 is a figure showing a timing chart for the second embodiment;

FIG. 12 is a figure showing the structure of the panel section of the third embodiment for the image display device of this invention;

FIG. 13 is a figure showing the structure of the panel section of the fourth embodiment for the image display device of this invention; and

FIG. 14 is a drawing showing the switch structure of the fourth embodiment.

### DETAILED DESCRIPTION OF THE PREFERRED EMBODIMENTS

The image display device of this invention is described next in detail while referring to the accompanying drawings. Identical sections are assigned the same reference numerals and redundant descriptions are omitted.

### First Embodiment

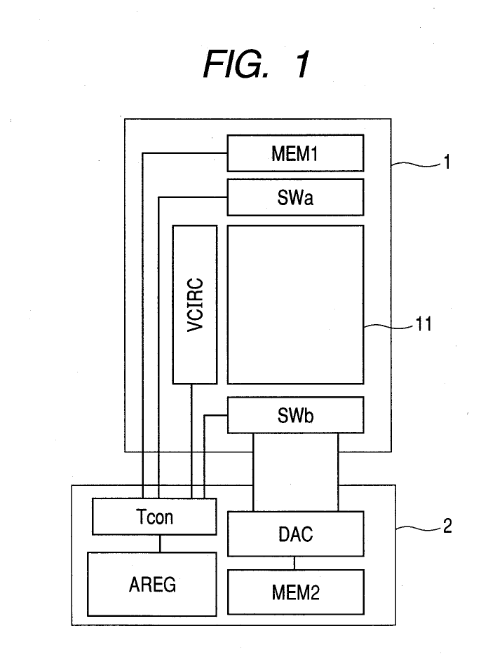

FIG. 1 is a block diagram showing the first embodiment of the image display device of the present invention. The image display device of this invention is made up of a panel section 1 and a driver IC 2. A display area 11 made up of TFT (thin film transistor), a vertical circuit VCIRC, an internal memory MEM1, a switch SWa, and a switch SWb are formed on the panel section 1.

The display on the display area 11 is performed utilizing liquid crystal or organic EL (electroluminescent) devices, etc. The driver IC 2 on the other hand, includes a digital/analog converter DAC, a memory MEM2, a timing controller Tcon, and an address register AREG. The panel section 1 uses the signal from the driver IC 2 to display the image. Signals to the panel section 1 from the driver IC 2 are a control signal from the timing controller Tcon, and an analog image signal from the digital/analog converter DAC. The control signal from the timing controller Tcon operates the vertical circuit VCIRC, an internal memory MEM1, the switch SWa, and the switch SWb inside the panel section 1. The internal memory MEM1 is a DRAM for accumulating electrical charges as capacitance, or is a SRAM connected respectively to the input and output of two inverters.

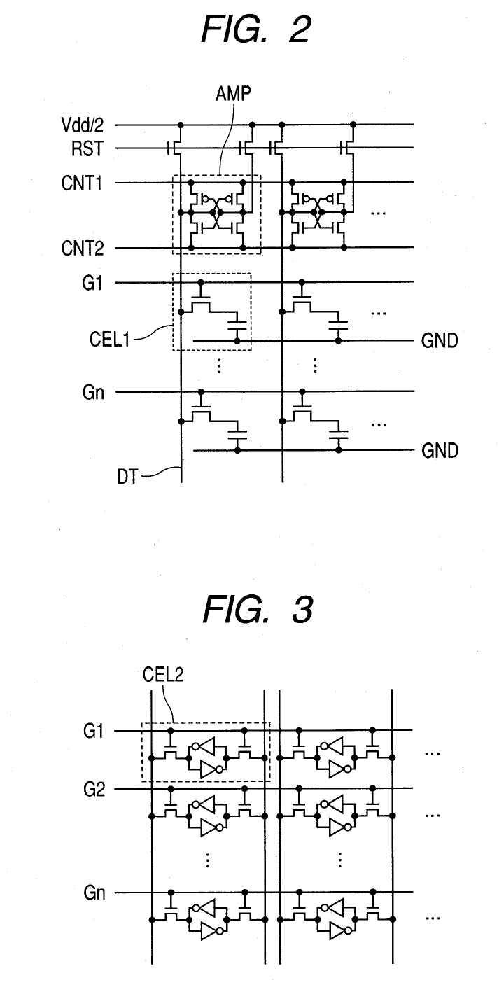

An example of the internal memory MEM1 structure is shown in FIG. 2 and FIG. 3. In FIG. 2, the internal memory is a DRAM that accumulates electrical charges in a capacitance. The memory cell CEL1 (FIG. 2) is made up of one capacitor and one transistor. The AMP in FIG. 2, is an amplifier containing two CMOS (Complimentary MOS) inverters made up of a P-type MOS transistor and an N-type MOS transistor. This AMP amplifies the tiny voltage changes in the data voltage and outputs the amplified data. The operation during readout is briefly described here. During data readout, the reset line RST is first turned on, and the data line DT voltage is set to half the supply voltage or in other words, set to VDD/2. The gate signal G1 is next turned on, and data stored in the memory cell CEL1 is output to the data line DT. The change in data voltage at this time is tiny however and so must be amplified. The voltage on the data line can here be amplified to a high state (the supply voltage VDD) or to a low state (the ground potential GND) by supplying an amplifier AMP supply voltage, and is then output. The CNT1 is a control signal line for changing the VDD (supply voltage) while the amplifier is operating from a voltage VDD/2. The CNT2 is a control signal line for switching to GND (ground) while the amplifier is operating from a voltage VDD/2.

The internal memory in FIG. 3 is a SRAM connected respectively to the input and output of two inverters. The memory cell CEL2 is made up of six transistors.

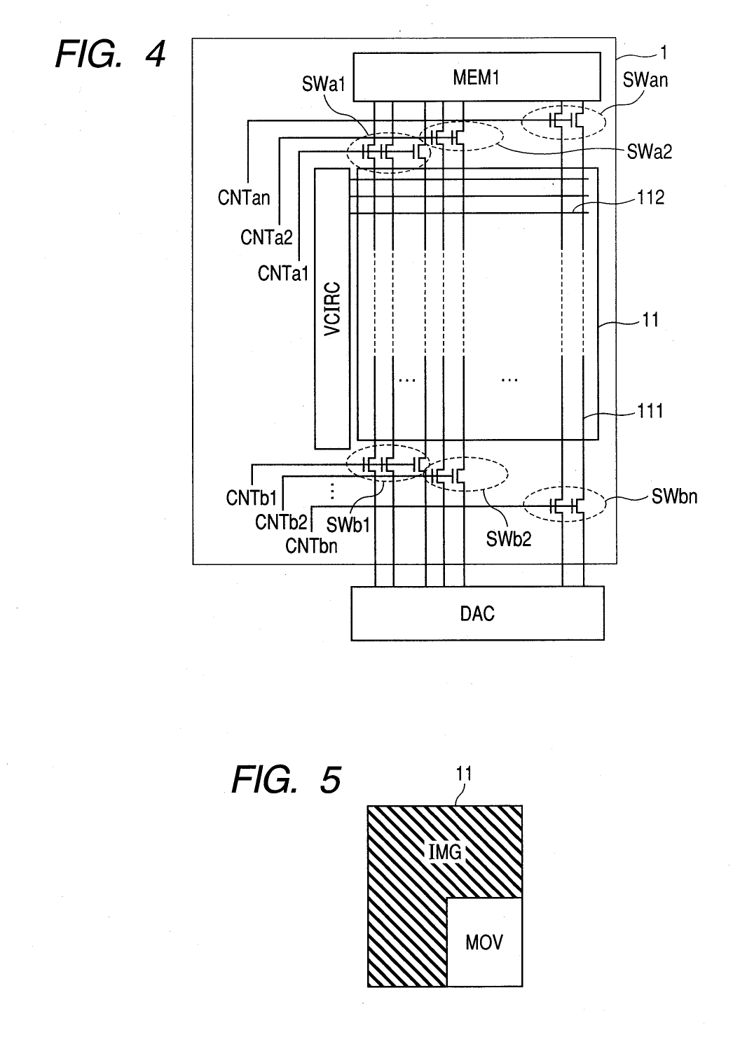

An example of the panel section 1 structure is described next in detail while referring to FIG. 4. Plural data lines 111 are arrayed in the vertical direction, and plural scanning lines 112 are arrayed in the horizontal direction in the display area 11 within the panel section 1. The data lines 111 are connected to the internal memory MEM1 on the upper section of the display area via the plural switches SWa1, SWa2, . . . , SWan. The data lines 111 also connect to the digital analog converter DAC outside the panel section 1 via the plural switches SWb1, SWb2, . . . , SWbn. The plural switches SWa1 and the plural switches SWb1 are here switches connected to the same data line among the plural data lines 111. In the same way, the plural switches SWa2 and the plural switches SWb2 are switches connected to the same data line, and so on. The plural switches SWa1, SWa2, . . . , SWan, and the plural switches SWb1, SWb2, . . . , SWbn are subdivided n times, however the number of subdivisions and the number of individual switches within each group are optional.

The control signals CNTa1, CNTa2, . . . , CNTan respectively control the switches SWa1, SWa2, . . . , SWan. The control signals CNTb1, CNTb2, . . . , CNTbn in the same way respectively control the SWb1, SWb2, . . . , SWbn.

As shown in FIG. 4, the control signals CNTa1, CNTa2, . . . , CNTan and the control signals CNTb1, CNTb2, . . . , CNTbn are here control signals output from the timing controller Tcon inside the driver IC 2 of FIG. 1. The scanning lines 112 are signal lines driven by the vertical circuit VCIRC. The sequence for displaying an image synthesized from the static image IMG and the moving image MOV on the display area 11 shown in FIG. 5 is described next utilizing the image display device structured as described above. The image data stored in the internal memory MEM1 is displayed here in the area for showing the static image IMG, and the image data for the internal memory MEM2 within the driver IC 2 is displayed in the area for showing the moving image MOV.

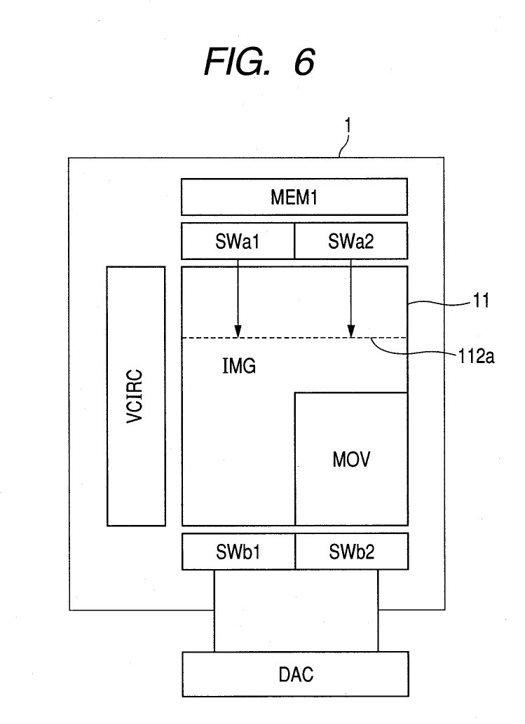

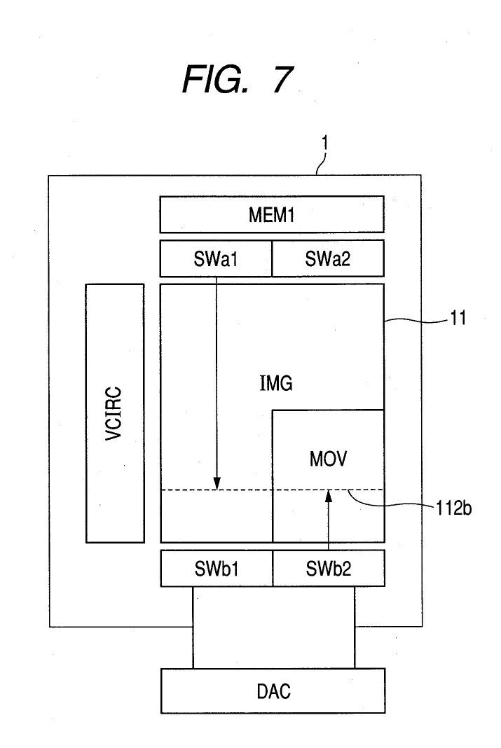

FIG. 6 and FIG. 7 are panel sections on the display device for showing the static images and moving images shown in the display device in FIG. 5. The switches for connecting the display area 11 with the internal memory MEM1 are made up of two blocks called the switch SWa1 and the switch SWa2. The switches for connecting the display area 11 with the digital/analog converter DAC are made up of two blocks called the switch SWb1 and the switch SWb2. The image signal flow when the scanning line 112a is selected by the vertical circuit VCIRC is shown by the arrows in FIG. 6. The pixels connected to the scanning lines 112a are all for displaying the static image IMG so that data from the internal memory MEM1 must be transferred to the pixels. The switches SWa1 and SWa2 must therefore be turned on, and the switches SWb1 and SWb2 must be turned off.

On the other hand, the image signal flow when the scanning line 112b is selected by the vertical circuit VCIRC is shown using the arrows in FIG. 7. The pixels connected to the scanning lines 112b are displayed as static images IMG on the left half, and as moving images MOV on the right half so that data from the internal memory MEM1 is transferred to the pixels on the left half, and data from the digital/analog converter DAC is transferred to the pixels on the right half. The switches SWa1 and SWb2 must therefore be turned on and the switches SWb1 and SWa2 must be turned off at this time.

The image display device of this invention contains an internal memory MEM1 and operates the image data input selector switches SWa and SWb every time a scanning line is selected. Power consumption is therefore reduced since only the moving image data must be newly loaded when simultaneously showing static images IMG and moving images MOV. Moreover, the internal memory MEM1 is mounted on the panel section 1 outside the display area 11 to allow higher circuit integration and the pixel size can be kept small.

Although it is described that the displaying of the combined image data is based on the static image data and the moving image data, the invention is applicable to other cases. For example, the invention is applicable to the case of displaying of a combined image data based on two different static image data. Further, in view of power consumption, it is particularly effective to apply the present invention when the change of the image data supplied from the driver IC 2 is faster than the change of the image data stored in the internal memory MEM1.

### Second Embodiment

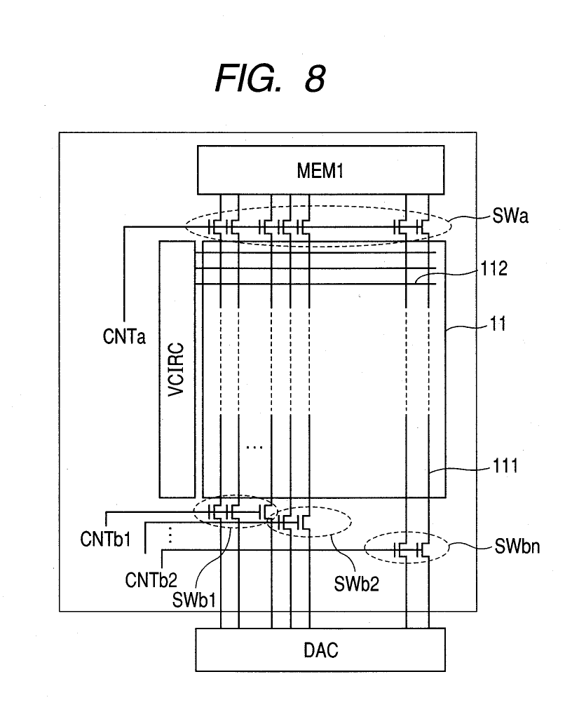

The image display device of the second embodiment of this invention is described next while referring to FIG. 8. The panel section 1 of the image display shown in FIG. 8 is the same as in FIG. 4, yet the switch structure for connecting the internal memory MEM1 to the data lines 111 is different from the structure in FIG. 4 of the first embodiment. In FIG. 4, the switches connecting the data line 111 and the internal memory MEM1 are made up of plural switch groups SWA1, SWa2, . . . , SWan. In FIG. 8 however, all switches are plural switches SWa controlled by the control signal CNTa. The sequence for displaying an image synthesized from the static image and the moving image of FIG. 5 in the image display device of this embodiment are described next.

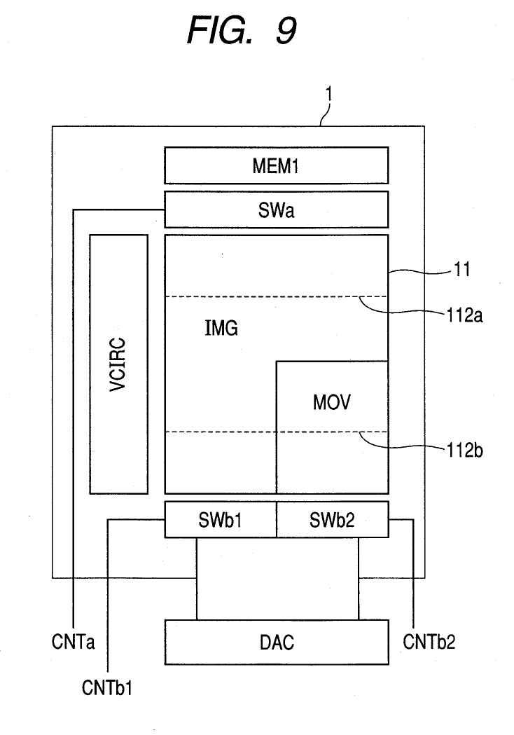

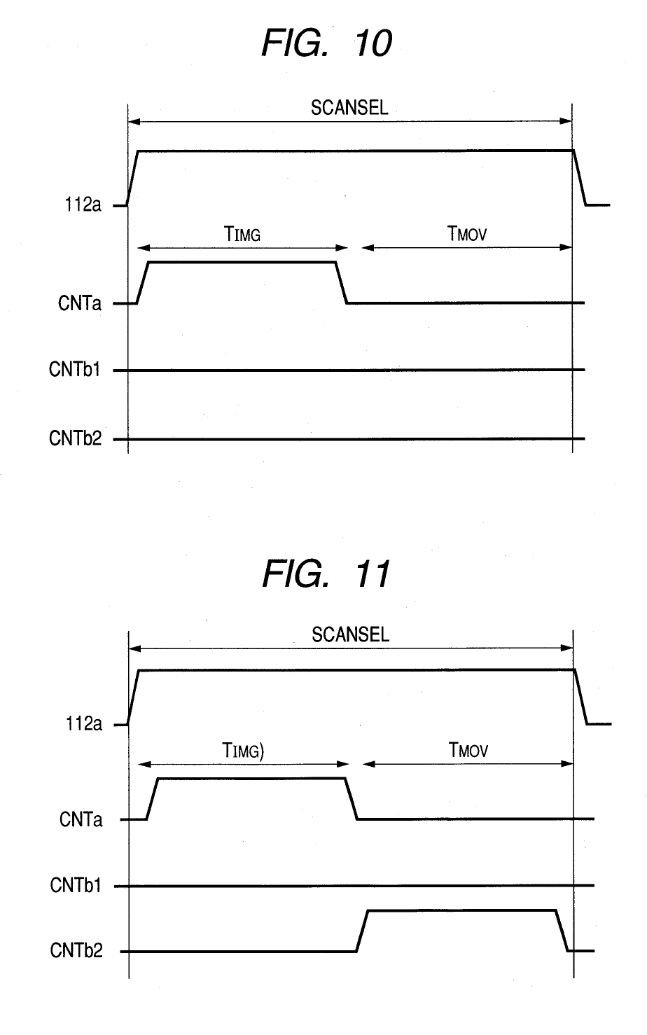

FIG. 9 is a drawing showing the panel section 1 for displaying the image in FIG. 5. The switch SWa is the switch connecting the display area 11 and the internal memory MEM1. The switches for connecting the display area 11 to the digital/analog converter DAC are made up of the two blocks switch SWb1 and switch SWb2. FIG. 10 is a timing chart showing the timing of the switch control signals CNTa, CNTb1, CNTb2 when the panel selects the scanning lines 112a and sends the static image on the data line.

As shown in FIG. 10, the first half of the scanning line select period (SCANSEL) is set to the static image data transfer period T_{IMG}, and the latter half is set in the moving image data transfer period T_{MOV}. The panel section therefore sets the switch control signal CNTa to HIGH level in the static image data transfer period T_{IMG} of the first half of the scanning line select period. In the moving image data transfer period T_{MOV} in the latter half on the other hand, there is no transfer of moving images so the switch control signals CNTb1, CNTb2 are kept at a LOW level in the first and the latter halves.

The panel section next selects the scanning line 112 and the switch control signals CNTa, CNTb1, CNTb2 timing when sending the static image data IMG to the left half, and the moving image data MOV on the data line to the right half (of the scanning line select period) is shown in the timing chart in FIG. 11. In this case, setting the switch control signal CNTa to a HIGH level in the static image data transfer period T_{IMG} for the first half of one scanning line select period sends the static image IMG to one line of pixels. Next, setting the switch control signal CNTb2 to a HIGH level in the moving image data transfer period T_{MOV}, in the latter half, rewrites the pixel data for displaying the moving image data into the image data MOV. This scanning allows displaying the image of FIG. 5.

This embodiment also contains a switch SWa for controlling transfer of static image data stored in the internal memory MEM1 to the data display area, and contains the switches SWb1 and SWb2 for transferring the moving image data sent from the DAC to the display area. By operating the switches according to the display position of both types of image data, only the moving image data need be newly loaded when simultaneously displaying the static image IMG and the moving image MOV so that power consumption is low. Moreover, the internal memory MEM1 is mounted on the panel section 1 outside the display area 11 so that the circuit can be more highly integrated and the pixel size be kept small.

### Third Embodiment

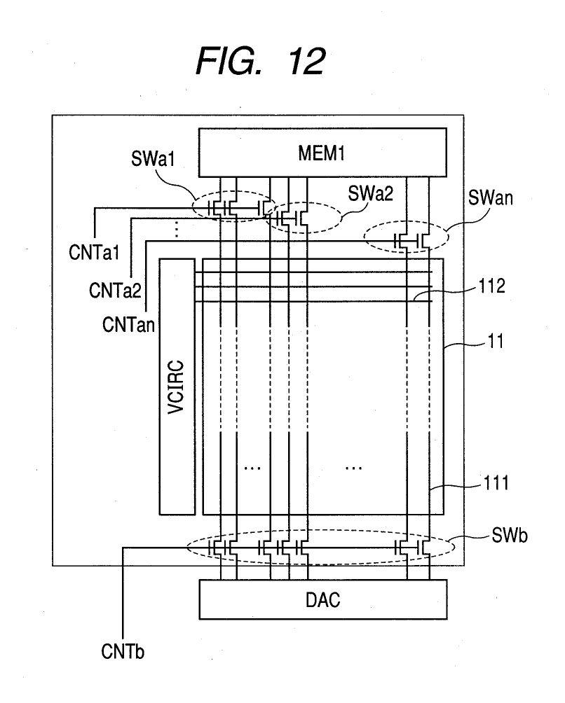

The image display device of the third embodiment of this invention is described next while referring to FIG. 12. Unlike the structure of the second embodiment shown in FIG. 8, in the structure shown in FIG. 12, the switch for connecting the data line 111 and the internal memory MEM1 is made up of plural switch groups SWA1, SWa2, . . . , SWan; and the switch for connecting between the data line 111 and the digital/analog converter DAC is made up of the switch SWb operated by the same control signal CNTb. To transfer image data in one scanning line select period, the moving image data MOV is sent in the first half (of the scanning select period), and the static image data IMG is sent in the latter half to allow image display. This embodiment contains an internal memory MEM1, and only the moving image data need be newly loaded by switching control, when simultaneously displaying the static image IMG and the moving image MOV so that low power consumption is achieved.

### Fourth Embodiment

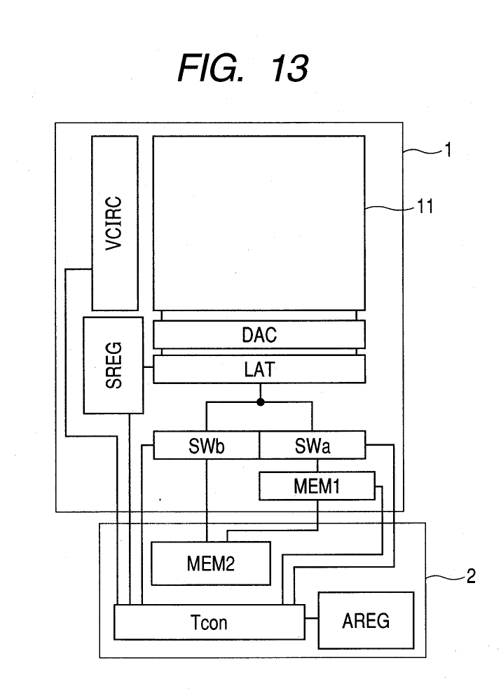

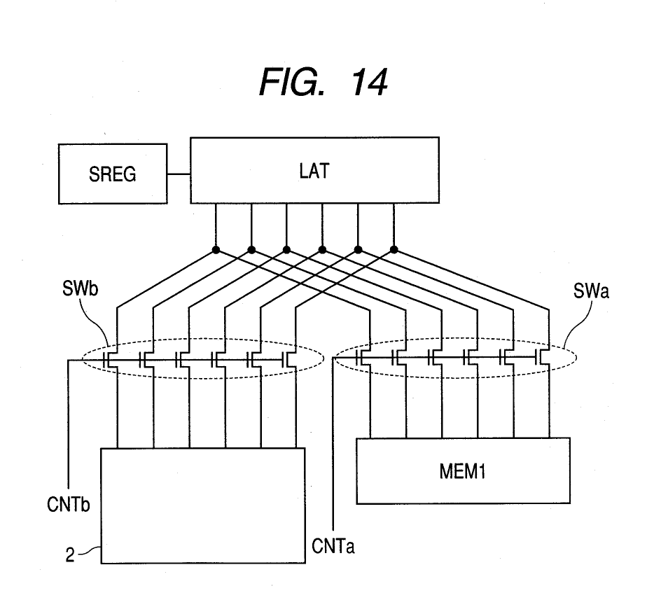

The image display device of the fourth embodiment of this invention is described next while referring to FIG. 13 and FIG. 14. Unlike the structure of the first embodiment shown in FIG. 1, the structure of the image display device of this embodiment as shown in FIG. 13 utilizes a digital/analog converter DAC formed on the panel section 1 board as the display area 11 using TFT (thin film transistors). The paths for transferring image data to the display area 11 in this image display device are: a path to the display area 11 from the internal memory MEM1 via the switch SWa, the latch LAT, and the analog/digital data converter DAC; and a path to the display area 11 from the memory MEM2 on the driver IC 2 via the switch SWb the latch LAT, and the analog/digital data converter DAC. The switch SWa and the switch SWb perform the switching between both these input paths.

The structure of the switch SWa and the switch SWb when transferring the six bit data is shown in FIG. 14. The input line for the latch LAT connects to the six switches SWa and the six switches SWb. A timing controller Tcon operates the switch SWa via a control signal CNTa. The timing controller Tcon operates the switch SWb via a control signal CNTb in the same way. A signal from the shift register SREG loads the image data into the latch LAT, and by setting either the switches SWa or the switches SWb to the ON state, and setting the other switches to the OFF state each time that the latch LAT loads the data, the static image data IMG of the internal memory MEM1 in the display area 11 and the moving image data MOV of the memory MEM2 on the driver IC 2 can be displayed as a composite image. Therefore, in this embodiment also, low power consumption can be achieved by loading just the moving image data when simultaneously displaying the static image IMG and the moving image MOV. Moreover, the internal memory MEM1 is mounted on the panel section 1 outside the display area 11 so that the circuit can be more highly integrated and the pixel size be kept small.

What is claimed is:

1. An image display device having plural data lines for transferring image data, plural scanning lines arrayed to intersect the plural data lines, and plural pixels corresponding to each of the points where the plural data lines and plural scanning lines intersect in a display area for displaying an image, the image display device comprising:
a first memory storing a first image data in an area outside the display area on a substrate where the display area is provided; and
a driver outputting a second image data different from the first image data to the plural data lines,
wherein an image data on the plural data lines is selectable for each data line from the first image data stored in the first memory, or the second image data supplied from the driver, and
wherein both of the selected first image data and the selected second image data are sent to the plural data lines in a period in which one of the plural scanning lines is selected.

2. The image display device according to claim 1, further comprising:
plural first switches selecting whether or not to send the first image data on the plural data lines; and
plural second switches selecting whether or not to send the second image data on the plural data lines,
wherein the plural first switches include a first switch group operated by a same first control signal, and
wherein the plural second switches include a second switch group operated by a same second control signal.

3. The image display device according to claim 2, wherein
in the period in which one of the plural scanning lines is selected,
the first image data stored in the first memory is sent to a part of the plural data lines by setting some of the first switches to an on state, and
the second image data is sent to another part of the plural data lines which are not sent the first image data by setting some of the second switches to an on state for sending the second image data to a data line where the first image data is not sent.

4. The image display device according to claim 2, wherein
in the period in which one of the plural scanning lines is selected,
the plural second switches are all set to an off state during setting of all the plural first switches to an on state so that the first image data is sent on the plural data lines, and
a part of the plural second switches are set to an on state after setting of all the plural first switches to an off state so that the second image data is sent on a part of the plural data lines.

5. An image display device according to claims 1, wherein the first image data is static image data, and the second image data is moving image data.

6. An image display device according to claim 1, wherein the first memory is DRAM.

7. An image display device according to claim 1, wherein the first memory is SRAM.

8. An image display device according to claim 1, wherein the first memory includes a thin film transistor.

9. An image display device according to claim 1, wherein the driver includes a digital/analog converter unit converting distal image signals to analog image signals and outputting the analog image signals as the second image data.

10. A display device comprising:
a panel section formed on a substrate and including a plurality of scanning lines, a plurality of data lines across the plurality of scanning lines, a plurality of pixels provided at the intersections of the plurality of data lines and the plurality of scanning lines, a first memory coupled to the plurality of data lines and storing a first image data; and
a driver connected to the panel section and outputting a second image data different from the first image data to the panel section,
wherein while one of the plural scanning lines is selected, a first part of the plurality of data lines is supplied the first image data from the first memory and a second part of the plurality of data lines different from the first part of the plurality of data lines is supplied the second image data from the driver.

11. The display device according to claim 10,
wherein the panel section further includes first switches between the first memory and the plurality of plurality of data lines and second switches between the driver and the plurality of data lines, the first switches transferring the first data from the first memory to the plurality of data lines and the second switches transferring the second data from the driver to the plurality of data lines, and
wherein the first data and the second data are provided to the plurality of data lines by selecting both of the first and second switches while one of the plurality of scanning line is selected.

12. The display device according to claim 11,
wherein the first image data is supplied to the first and second parts of the plurality of data lines and then the second image data is supplied to the second part of the plurality of data lines while one of the plurality of scanning lines is selected.

13. The display device according to claim 10,
wherein the panel section further includes
a digital-analog converter coupled to the plurality of data lines,
a latch circuit coupled to the digital-analog converter,
first switches between the first memory and the latch circuit, and
second switches between the driver and the latch circuit,
wherein the latch circuit takes in the second data from the driver and does not take in the first data from the first memory when the display device displays an image based on an image data combining the second image data with the first image data.

14. The display device according to claim 10,
wherein the first image data is a static image data and the second image data is a moving image data.

15. A display device comprising:
a panel section formed on a substrate and including:
a display area which has a plurality of scanning lines, a plurality of data lines across the plurality of scanning lines, and the plurality of pixels provided at the intersection of the plurality data lines, and the plurality of the scanning lines,
a first memory provided at the outside of the display area and storing a first image data,
a plurality of first switches coupled between the first memory and the plurality of data lines and outputting the first image data to the plurality of data lines, and
a plurality of second switches coupled to the plurality of data lines and outputting a second image data different from the first image data; and
a driver coupled to the panel section and outputting the second image data to the plurality of second switches,
wherein each of the plurality of data lines is coupled to one of the plurality of first switches and one of the plurality of second switches.

16. The display device according to claim 15,
wherein while one of the plurality of scanning lines is selected, the driver selects the first switch or the second switch for each data line.

17. The display device according to claim 15,
wherein while one of the plurality of scanning lines is selected, the driver selects the plurality of first switches and then selects a part of the plurality of second switches after turning off the plurality of first switches.

18. The display device according to claim 15,
wherein the first image data is a static image data and the second image data is a moving image data.
